(19) United States
(12) Patent Application Publication
(10) Pub. No.: US 2010/0258002 A1
(43) Pub. Date: Oct. 14, 2010

(54) ELMALEH ENGINE

(76) Inventor: Shimon ELMALEH, Pinecrest, FL (US)

Correspondence Address: ALBERT BORDAS, P.A., 5975 SUNSET DRIVE, SUITE 607, MIAMI, FL, 33143, US

(21) Appl. No.: 12/464,215

(22) Filed: May 12, 2009

(51) Int. Cl. F01B 23/10; H02K 7/075

(52) U.S. Cl. 91/55; 310/20

(57) ABSTRACT

A hydraulic/magnetic engine, comprising an engine assembly. Crankcase means are affixed within the engine assembly, and crankshaft means are positioned in the crankcase means. Cylinder means comprise at least two first cylinders being encased in the engine assembly and each including a first piston, at least two second pistons, and an electro-magnetic third piston. A hydraulic system has a hydraulic fluid chamber. First electro-magnetic means generates a first electromotive force, wherein switching magnetic polarity between a first and second openings forces a first piston, at least two second pistons, and an electro-magnetic third piston to move upward and downward within their respective cylinders. Thus, rotating the crankshaft means in a predetermined direction after an initial activation of the crankshaft means by applying a short period of an electrical force. The first electro-magnetic means is within the engine assembly.

### BACKGROUND OF THE INVENTION

1. Field of the Invention

The present invention relates to engines, and more particularly, to engines capable of operating by hydraulic and electromagnetic forces.

2. Description of the Related Art

Most vehicles, and especially automobiles, comprise internal combustion engines that run exclusively on gasoline. Other vehicles comprise engines having electrical means or hybrid means. There are no engines to Applicant's knowledge that combine the unique characteristics of the present invention to operate by hydraulic and electromagnetic forces.

Applicant believes that one of the closest references corresponds to Applicant's own pending U.S. patent application Ser. No. 12/237,792, filed on Sep. 25, 2008 for Electro-Magnetic Internal Combustion Engine. However, it differs from the present invention because Applicant's above-mentioned previous application teaches an electro-magnetic internal combustion engine having means to operate in an electro-magnetic configuration, in an internal combustion configuration, and in an electro-magnetic internal combustion combination configuration.

Other patents describing the closest subject matter provide for a number of more or less complicated features that fail to solve the problem in an efficient and economical way. None of these patents suggest the novel features of the present invention.

### SUMMARY OF THE INVENTION

The instant invention is an Elmaleh engine, comprising an engine assembly. Crankcase means are affixed within the engine assembly, and crankshaft means are positioned in the crankcase means. Cylinder means comprise at least two first cylinders being encased in the engine assembly and each including a first piston, at least two second pistons, and an electro-magnetic third piston.

The first piston has first and second ends. The first end is connected to a first piston rod. The first piston rod is assembled to the crankshaft means. Extending perpendicularly from the second end are at least two second piston rods that connect to the at least two second pistons respectively. Also extending perpendicularly from the second end is a third piston rod that connects to the electro-magnetic third piston. The electro-magnetic third piston comprises a magnetic body.

A hydraulic system has a hydraulic fluid chamber. The hydraulic fluid chamber is defined by a first top wall, a first bottom wall, and a first lateral wall. The first bottom wall comprises at least two second cylinders to receive the at least two second pistons respectively. The hydraulic fluid chamber further comprises a first inlet hydraulic fluid line and a first outlet hydraulic fluid line. The electro-magnetic third piston comprises a second top wall, a second bottom wall, and a second lateral wall. Extending from the second bottom wall to the first top wall is a lever. The lever has a spring force caused by a fulcrum positioned on the first top wall. The spring force biases the electro-magnetic third piston away from the first top wall of the hydraulic fluid chamber.

First electro-magnetic means consists of first coil means having first at least two coils. Each of the first at least two coils is arranged stationary around the cylinder means. Each of the first at least two coils has first and second openings. The first and second openings include first winding terminals electrically connected to a distributor. The distributor has synchronizing means to send a first electrical current to the first at least two coils to switch magnetic polarity. The first electro-magnetic means generates a first electromotive force between the first and second openings, and corresponding magnetic body when synchronized by the distributor, wherein switching the magnetic polarity between the first and second openings forces the first piston, the at least two second pistons, and the electro-magnetic third piston to move upward and downward within its respective the at least two first cylinders. Thus, rotating the crankshaft means in a predetermined direction after an initial activation of the crankshaft means by applying a short period of an electrical force. The first electro-magnetic means is within the engine assembly.

Electrical means electrically connect the first at least two coils to the distributor. The electrical means further comprises activation means from a power source for applying the short period of the electrical force.

The hydraulic fluid chamber comprises hydraulic fluid received via the first inlet hydraulic fluid line. The first inlet hydraulic fluid line comprises a first one-way valve. The first outlet hydraulic fluid line comprises a second one-way valve. The hydraulic system comprises a hydraulic pump. The hydraulic system further comprises a hydraulic plate assembly. The hydraulic plate assembly mounts upon a chassis assembly of a vehicle. The hydraulic plate assembly has a second inlet hydraulic fluid line and a second outlet hydraulic fluid line. The hydraulic plate assembly comprises at least one hydraulic rotor rotatably mounted onto a central shaft. The hydraulic rotor comprises second electro-magnetic means.

The second electro-magnetic means consists of second coil means having second at least two coils. Each of the second at least two coils is arranged stationary around the hydraulic plate assembly. Each of the second at least two coils has third and fourth openings. The third and fourth openings include second winding terminals electrically connected to the distributor. The distributor has the synchronizing means to send a second electrical current to the second at least two coils to switch magnetic polarity. The second electro-magnetic means generates a second electromotive force between the third and fourth openings, and corresponding electro-magnet when synchronized by the distributor, wherein switching the magnetic polarity between the third and fourth openings forces the hydraulic rotor to rotate upon the central shaft. Thus, forcing the hydraulic fluid out the second outlet hydraulic fluid line and to the hydraulic pump. The hydraulic pump forces the hydraulic fluid from the first outlet hydraulic fluid line and the second outlet hydraulic fluid line, to the first inlet hydraulic fluid line and the second inlet hydraulic fluid line, whereby the electrical means also electrically connects the second at least two coils to the distributor.

It is therefore one of the main objects of the present invention to provide an Elmaleh engine capable of operating by hydraulic and electromagnetic forces.

It is yet another object of this invention to provide such an engine that is inexpensive to manufacture and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents is a cross-sectioned schematic view of the present invention to better show its internal arrangement.

FIG. 1A is a detail view of one of the cylinder assemblies shown in FIG. 1.

FIG. 2 is a schematic view of a hydraulic plate assembly mounted upon a chassis assembly of a vehicle.

FIG. 2A is an isometric view of the hydraulic plate assembly.

FIG. 2B is a cross-section view of the hydraulic plate assembly, showing its internal components.

FIG. 2C is an isometric view of one of the hydraulic rotors of the hydraulic plate assembly.

FIG. 3 is a cross-section view of two hydraulic plate assemblies, stacked and showing their internal components.

### DETAILED DESCRIPTION OF THE PREFERRED EMBODIMENT

Referring now to the drawings, the present invention is generally referred to with numeral 10. It can be observed that it basically includes engine assembly 20, cylinder assembly 40, piston assembly 60, electro-magnetic piston assembly 80, and hydraulic system 200.

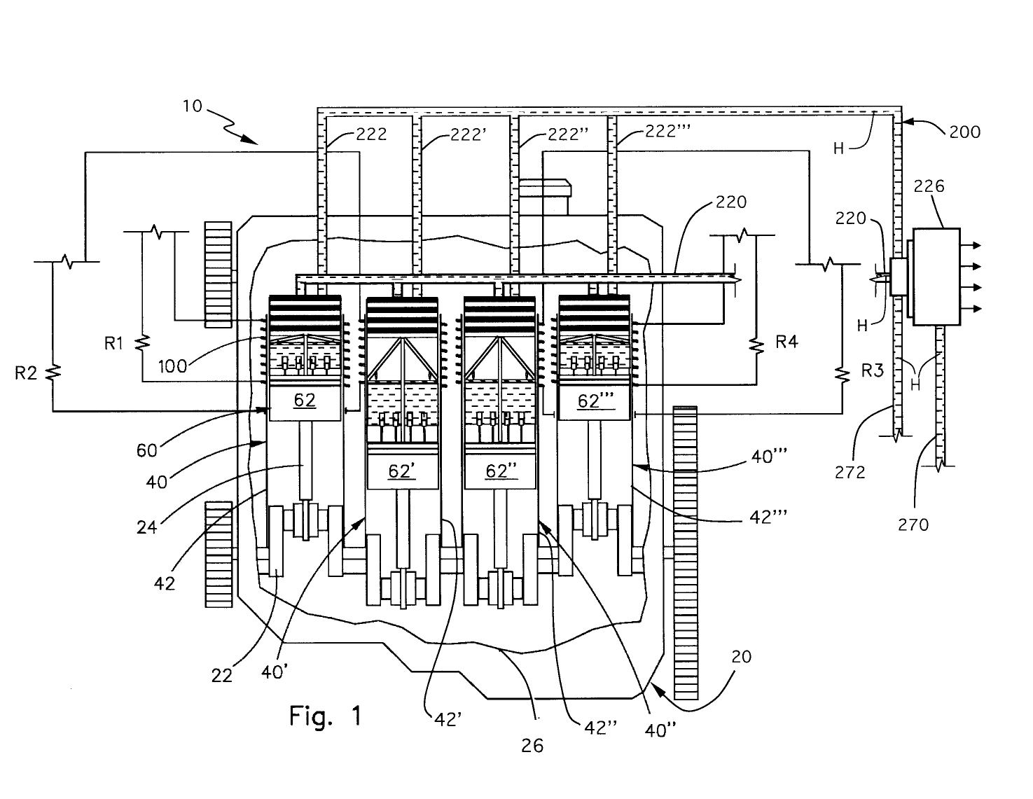

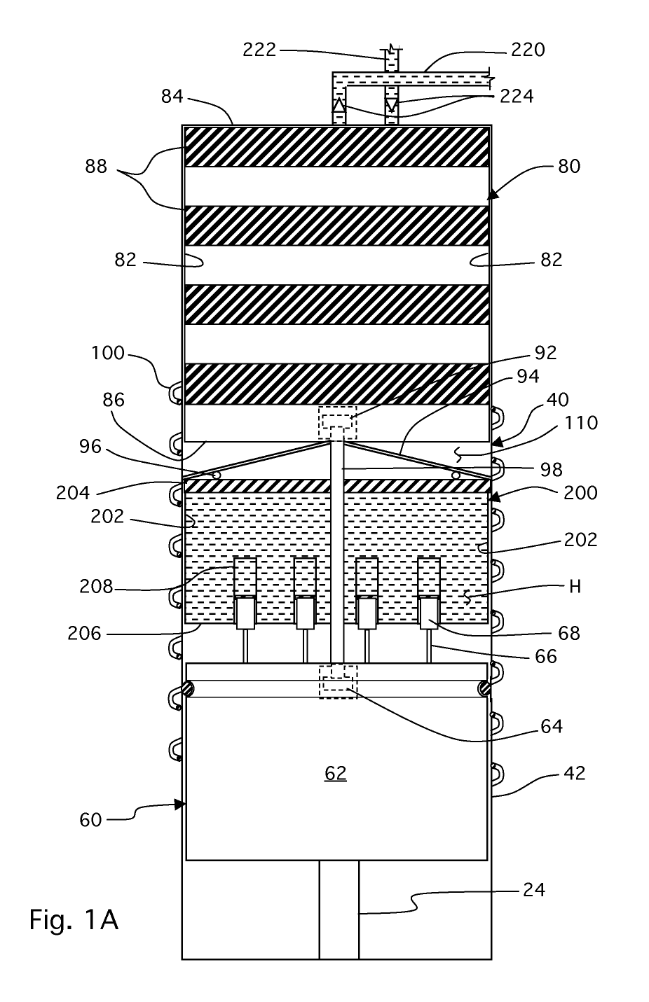

As seen in FIG. 1, engine assembly 20 comprises crankcase means 26. Crankshaft 22 serves as crankshaft means and is positioned in crankcase means 26. Cylinder means defines cylinder assemblies 40, 40′, 40″ and 40″′, which are encased in engine assembly 20. Cylinder means comprises pistons 62, 62′, 62″ and 62′″. Each of pistons 62, 62′, 62″ and 62′″ has first and second ends. The first end is connected to piston rod 24. Piston rod 24 is assembled to crankshaft 22.

Referring to FIGS. 1 and 1A, hydraulic system 200 has a hydraulic fluid chamber that is stationary and is defined by top wall 204, bottom wall 206, and lateral wall 202. It is noted that for ease of illustration, only piston 62 of piston assembly 60 is illustrated, but pistons 62′, 62″, and 62′″ also comprise these components. The hydraulic fluid chamber further comprises inlet hydraulic fluid line 220 and outlet hydraulic fluid line 222. Inlet hydraulic fluid line and each of outlet hydraulic fluid lines 220 and 222, 222′, 222″, and 222′″ comprise one-way valve 224. Hydraulic system 200 further comprises hydraulic pump 226.

Electro-magnetic means consists of electro-magnetic coils 100 arranged stationary around the cylinder means. Each of electro-magnetic coils 100 has first and second winding terminals that are electrically connected to a distributor, not seen. The distributor has synchronizing means to send electrical current to the electro-magnetic coils 100 to switch magnetic polarity. The electro-magnetic means generate an electromotive force between the first and second winding terminals and corresponding magnetic body 88 when synchronized by the distributor. Switching the magnetic polarity between first and second winding terminal forces piston 62, pistons 68, and electro-magnetic piston 80 to move upward and downward within its respective cylinder 42, thus rotating crankshaft means 22 in a predetermined direction after an initial activation of crankshaft means 22 by applying a short period of an electrical force. The electro-magnetic means are within engine assembly 20.

Electrical means electrically connect electro-magnetic coils 100 to the distributor. The electrical means further comprises activation means from a power source for applying the short period of electrical force, and resistors R1, R2, R3, and R4.

As best seen in FIG. 1A, cylinder means also comprises pistons 68 and electro-magnetic piston assembly 80. Bottom wall 206 comprises cylinders 208 to receive pistons 68. The hydraulic fluid chamber comprises hydraulic fluid H received via inlet hydraulic fluid line 220. Extending perpendicularly from the second end of piston 62 are piston rods 66 that connect to pistons 68, respectively. Also extending perpendicularly from the second end of piston 62 at connecting point 64 is piston rod 98 that connects to electro-magnetic piston assembly 80 at connecting point 92.

Electro-magnetic piston 80 comprises top wall 84, bottom wall 86, and lateral wall 82. Electro-magnetic piston assembly 80 also comprises magnetic body 88. Extending from bottom wall 86 to top wall 204 is lever 94, which has a spring force caused by fulcrum 96 positioned on top wall 204 within cavity 110. The spring force biases electro-magnetic piston assembly 80 away from top wall 204 of the hydraulic fluid chamber.

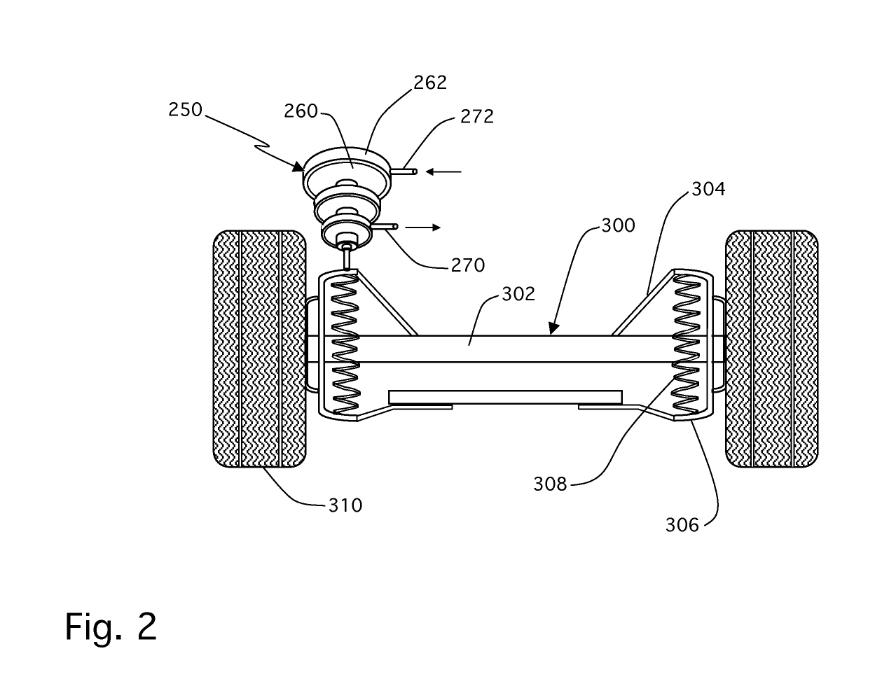

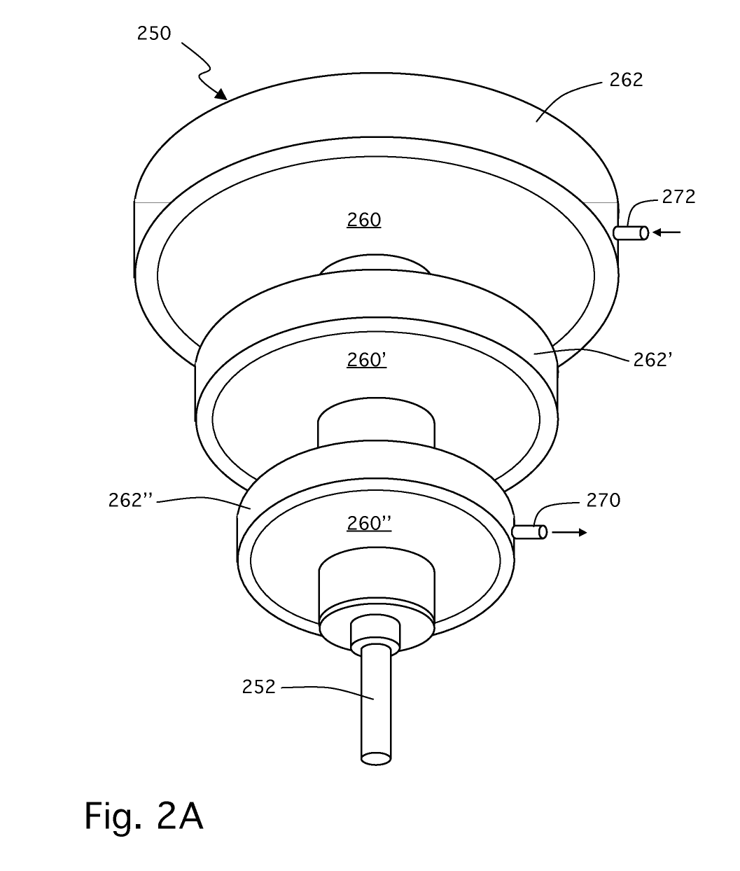

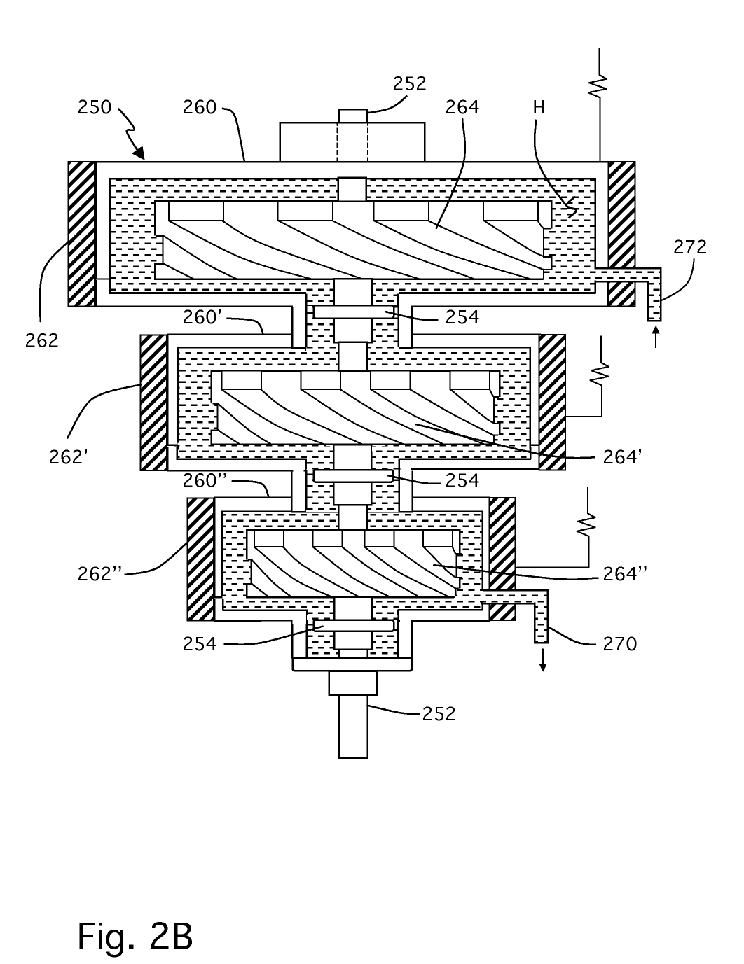

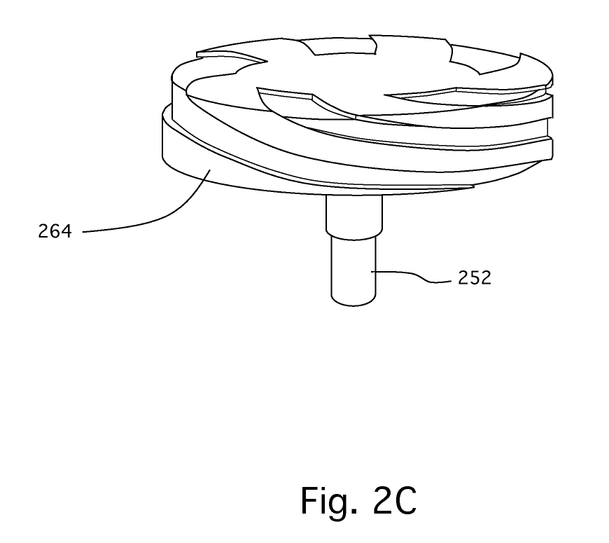

As seen in FIG. 2, hydraulic system 200 further comprises hydraulic plate assembly 250 that mounts upon a chassis assembly 300 of a vehicle. Hydraulic plate assembly 250 has inlet hydraulic fluid line 272 and outlet hydraulic fluid line 270. Such a vehicle may comprise axle 302 having support member 304 welded thereon. Axle 302 will require a spring 308 affixed to base 306. Mounted onto axle 302 is a wheel assembly 310.

As best seen in FIGS. 2A, 2B, and 2C, hydraulic system 200 further comprises hydraulic rotors 264, 264′ and 264″. Hydraulic rotors 264, 264′ and 264″ rotatably mount onto central shaft 252. Hydraulic rotors 264, 264′ and 264″ comprise electro-magnets 262, 262′ and 262″ arranged stationary around hydraulic plate rotors 264, 264′ and 264″. Shaft 252 has multiple bearings 254. Hydraulic plate assembly 250 also comprises exterior plates 260, 260′, and 260″. Although not illustrated, each of electro-magnets 262, 262′ and 262″ has winding terminals also as electro-magnetic means, that are electrically connected to the distributor. The distributor has synchronizing means to send electrical current to electro-magnets 262, 262′ and 262″ to switch magnetic polarity. Electro-magnets 262, 262′ and 262″ generate an electromotive force that forces hydraulic rotors 264, 264′ and 264″ to rotate upon central shaft 252. Thus, forcing hydraulic fluid H out outlet hydraulic fluid line 270 and to hydraulic pump 226, seen in FIG. 1.

Hydraulic pump 226 forces hydraulic fluid H from outlet hydraulic fluid line 222, 222′, 222″, and 222′″ and outlet hydraulic fluid line 270 to inlet hydraulic fluid line 220 and inlet hydraulic fluid line 272, whereby the electrical means also electrically connects electro-magnets 262, 262′ and 262″ to the distributor. The configuration of one of hydraulic rotors 264, the same of 264′ and 264″, of hydraulic plate assembly 250 is best seen in FIG. 2C. The shape and disposition of the illustrated shape of channels facilitate hydraulic fluid H to urge the rotation of hydraulic rotors 264, the same of 264′ and 264″. Hydraulic rotors 264, 264′, and 264″ may operate as a battery or energy source in a pressure chamber.

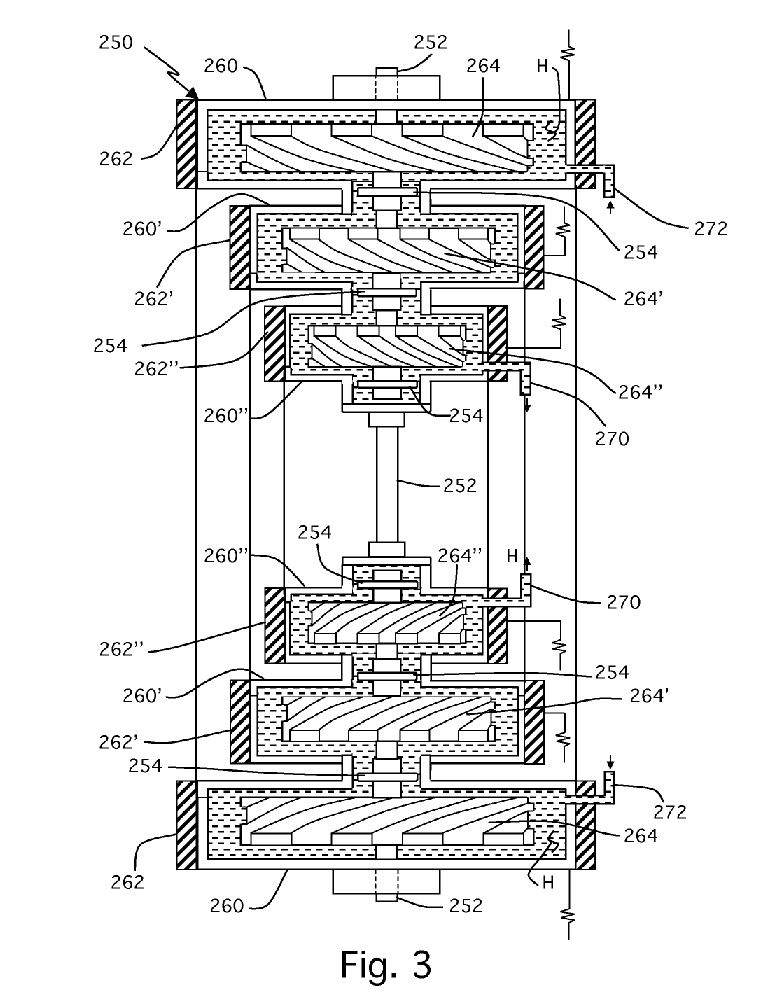

As seen in FIG. 3, two hydraulic plate assemblies 250 can be arranged as shown to increase the efficiency and/or effectiveness of present invention 10.

The foregoing description conveys the best understanding of the objectives and advantages of the present invention. Different embodiments may be made of the inventive concept of this invention. Such embodiments include the magnetic materials to be of different materials, including but not limited to iron and materials that operate with plasma magnetism. It is to be understood that all matter disclosed herein is to be interpreted merely as illustrative, and not in a limiting sense.

What is claimed is:

1. A hydraulic/magnetic engine, comprising:
A) an engine assembly;
B) crankcase means, said crankcase means being affixed within said engine assembly;
C) crankshaft means, said crankshaft means being positioned in said crankcase means;
D) cylinder means comprising at least two first cylinders being encased in said engine assembly and each including a first piston, at least two second pistons, and an electro-magnetic third piston, said first piston having first and second ends, said first end connected to a first piston rod, said first piston rod being assembled to said crankshaft means, extending perpendicularly from said second end are at least two second piston rods that connect to said at least two second pistons respectively, also extending perpendicularly from said second end is a third piston rod that connects to said electro-magnetic third piston, said electro-magnetic third piston comprises a magnetic body;
E) a hydraulic system having a hydraulic fluid chamber, said hydraulic fluid chamber defined by a first top wall, a first bottom wall, and a first lateral wall, said first bottom wall comprising at least two second cylinders to receive said at least two second pistons respectively, said hydraulic fluid chamber further comprising a first inlet hydraulic fluid line and a first outlet hydraulic fluid line;
F) first electro-magnetic means, said first electro-magnetic means consisting of first coil means having first at least two coils, each of said first at least two coils arranged stationary around said cylinder means, each of said first at least two coils having first and second openings, said first and second openings include first winding terminals electrically connected to a distributor, said distributor having synchronizing means to send a first electrical current to said first at least two coils to switch magnetic polarity, said first electro-magnetic means generate a first electromotive force between said first and second openings, and corresponding said magnetic body when synchronized by said distributor, wherein switching said magnetic polarity between said first and second openings forces said first piston, said at least two second pistons, and said electro-magnetic third piston to move upward and downward within its respective said at least two first cylinders thus rotating said crankshaft means in a predetermined direction after an initial activation of said crankshaft means by applying a short period of an electrical force, said first electro-magnetic means being within said engine assembly; and
G) electrical means to electrically connect said first at least two coils to said distributor, said electrical means further comprises activation means from a power source for applying said short period of said electrical force.

2. The hydraulic/magnetic engine set forth in claim 1, further characterized in that said electro-magnetic third piston comprises a second top wall, a second bottom wall, and a second lateral wall, extending from said second bottom wall to said first top wall is a lever, said lever having a spring force caused by a fulcrum positioned on said first top wall, said spring force biasing said electro-magnetic third piston away from said first top wall of said hydraulic fluid chamber.

3. The hydraulic/magnetic engine set forth in claim 1, further characterized in that said hydraulic fluid chamber comprises hydraulic fluid received via said first inlet hydraulic fluid line, said first inlet hydraulic fluid line comprises a first one-way valve.

4. The hydraulic/magnetic engine set forth in claim 3, further characterized in that said first outlet hydraulic fluid line comprises a second one-way valve.

5. The hydraulic/magnetic engine set forth in claim 1, further characterized in that said hydraulic system comprises a hydraulic pump.

6. The hydraulic/magnetic engine set forth in claim 5, further characterized in that said hydraulic system further comprises a hydraulic plate assembly, said hydraulic plate assembly mounts upon a chassis assembly of a vehicle, said hydraulic plate assembly having a second inlet hydraulic fluid line and a second outlet hydraulic fluid line.

7. The hydraulic/magnetic engine set forth in claim 6, further characterized in that said hydraulic plate assembly comprises at least one hydraulic rotor rotatably mounted onto a central shaft.

8. The hydraulic/magnetic engine set forth in claim 7, further characterized in that said hydraulic rotor comprises second electro-magnetic means, said second electro-magnetic means consisting of second coil means having second at least two coils, each of said second at least two coils arranged stationary around said hydraulic plate assembly, each of said second at least two coils having third and fourth openings, said third and fourth openings include second winding terminals electrically connected to said distributor, said distributor having said synchronizing means to send a second electrical current to said second at least two coils to switch magnetic polarity, said second electro-magnetic means generate a second electromotive force between said third and fourth openings, and corresponding said electro-magnet when synchronized by said distributor, wherein switching said magnetic polarity between said third and fourth openings forces said hydraulic rotor to rotate upon said central shaft thus forcing said hydraulic fluid out said second outlet hydraulic fluid line and to said hydraulic pump.

9. The hydraulic/magnetic engine set forth in claim 8, further characterized in that said hydraulic pump forces said hydraulic fluid from said first outlet hydraulic fluid line and said second outlet hydraulic fluid line, to said first inlet hydraulic fluid line and said second inlet hydraulic fluid line, whereby said electrical means also electrically connects said second at least two coils to said distributor.

10. A hydraulic/magnetic engine, comprising:
A) an engine assembly;
B) crankcase means, said crankcase means being affixed within said engine assembly;
C) crankshaft means, said crankshaft means being positioned in said crankcase means;
D) cylinder means comprising at least two first cylinders being encased in said engine assembly and each including a first piston, at least two second pistons, and an electro-magnetic third piston, said first piston having first and second ends, said first end connected to a first piston rod, said first piston rod being assembled to said crankshaft means, extending perpendicularly from said second end are at least two second piston rods that connect to said at least two second pistons respectively, also extending perpendicularly from said second end is a third piston rod that connects to said electro-magnetic third piston, said electro-magnetic third piston comprises a magnetic body;
E) a hydraulic system having a hydraulic fluid chamber, said hydraulic fluid chamber defined by a first top wall, a first bottom wall, and a first lateral wall, said first bottom wall comprising at least two second cylinders to receive said at least two second pistons respectively, said hydraulic fluid chamber further comprising a first inlet hydraulic fluid line and a first outlet hydraulic fluid line, said electro-magnetic third piston comprises a second top wall, a second bottom wall, and a second lateral wall, extending from said second bottom wall to said first top wall is a lever, said lever having a spring force caused by a fulcrum positioned on said first top wall, said spring force biasing said electro-magnetic third piston away from said first top wall of said hydraulic fluid chamber;
F) first electro-magnetic means, said first electro-magnetic means consisting of first coil means having first at least two coils, each of said first at least two coils arranged stationary around said cylinder means, each of said first at least two coils having first and second openings, said first and second openings include first winding terminals electrically connected to a distributor, said distributor having synchronizing means to send a first electrical current to said first at least two coils to switch magnetic polarity, said first electro-magnetic means generate a first electromotive force between said first and second openings, and corresponding said magnetic body when synchronized by said distributor, wherein switching said magnetic polarity between said first and second openings forces said first piston, said at least two second pistons, and said electro-magnetic third piston to move upward and downward within its respective said at least two first cylinders thus rotating said crankshaft means in a predetermined direction after an initial activation of said crankshaft means by applying a short period of an electrical force, said first electro-magnetic means being within said engine assembly; and
G) electrical means to electrically connect said first at least two coils to said distributor, said electrical means further comprises activation means from a power source for applying said short period of said electrical force.

11. The hydraulic/magnetic engine set forth in claim 10, further characterized in that said hydraulic fluid chamber comprises hydraulic fluid received via said first inlet hydraulic fluid line, said first inlet hydraulic fluid line comprises a first one-way valve.

12. The hydraulic/magnetic engine set forth in claim 11, further characterized in that said first outlet hydraulic fluid line comprises a second one-way valve.

13. The hydraulic/magnetic engine set forth in claim 12, further characterized in that said hydraulic system comprises a hydraulic pump.

14. The hydraulic/magnetic engine set forth in claim 13, further characterized in that said hydraulic system further comprises a hydraulic plate assembly, said hydraulic plate assembly mounts upon a chassis assembly of a vehicle, said hydraulic plate assembly having a second inlet hydraulic fluid line and a second outlet hydraulic fluid line.

15. The hydraulic/magnetic engine set forth in claim 14, further characterized in that said hydraulic plate assembly comprises at least one hydraulic rotor rotatably mounted onto a central shaft.

16. The hydraulic/magnetic engine set forth in claim 15, further characterized in that said hydraulic rotor comprises second electro-magnetic means, said second electro-magnetic means consisting of second coil means having second at least two coils, each of said second at least two coils arranged stationary around said hydraulic plate assembly, each of said second at least two coils having third and fourth openings, said third and fourth openings include second winding terminals electrically connected to said distributor, said distributor having said synchronizing means to send a second electrical current to said second at least two coils to switch magnetic polarity, said second electro-magnetic means generate a second electromotive force between said third and fourth openings, and corresponding said electro-magnet when synchronized by said distributor, wherein switching said magnetic polarity between said third and fourth openings forces said hydraulic rotor to rotate upon said central shaft thus forcing said hydraulic fluid out said second outlet hydraulic fluid line and to said hydraulic pump.

17. The hydraulic/magnetic engine set forth in claim 16, further characterized in that said hydraulic pump forces said hydraulic fluid from said first outlet hydraulic fluid line and said second outlet hydraulic fluid line, to said first inlet hydraulic fluid line and said second inlet hydraulic fluid line, whereby said electrical means also electrically connects said second at least two coils to said distributor.
